(19) United States
(12) Patent Application Publication
(10) Pub. No.: US 2002/0192487 A1
(43) Pub. Date: Dec. 19, 2002

(54) ALUMINUM-ALLOY-BASED SLIDING MATERIAL

(76) Inventors: SHOGO MURAMATSU, AICHI (JP); SOO-MYUNG HONG, AICHI (JP)

Correspondence Address: ARMSTRONG,WESTERMAN & HATTORI, LLP, 1725 K STREET, NW., SUITE 1000, WASHINGTON, DC, 20006, US

(21) Appl. No.: 09/423,981

(22) PCT Filed: Mar. 17, 1999
(86) PCT No.: PCT/JP99/01302

(30) Foreign Application Priority Data
Mar. 18, 1998 (JP) 10-68951

(51) Int. Cl. B32B 15/20

(52) U.S. Cl. 428/612; 428/654; 428/653; 428/650; 428/937; 384/912

(57) ABSTRACT

In aluminum alloy which is required to have good sliding characteristics, excellent sliding characteristics are achieved by carrying out granulation while avoiding the formation of flakes from Si particles through thermally spraying an aluminum alloy containing Si in an amount of 12 to 60 % The aluminum alloy may contain 0.1 to 30% of Sn, in addition to Si.

### TECHNICAL FIELD

The present invention is related to aluminum-alloy having improved sliding properties. More particularly, the sliding properties of aluminum alloy according to the present invention are enhanced by utilizing the flame-spraying technique.

### BACKGROUND TECHNIQUE

The following are known aluminum-alloy based sliding materials required to have such properties as wear-resistance and seizure-resistance.

(a) An Al—Si based melted alloy (Alusil alloy). The wear-resistance due to the eutectic Si or primary Si is utilized. The Si content in this alloy is generally from 3 to 18%. Forging, casting and the like work this alloy into the material shape.

(b) In the process of working the aluminum alloy into a rolled sheet and heat-treating the same, such hard particles as Si particles and Fe particles are nodularized (German Patent No. 3249133 of the present applicant). Improved seizure resistance and the like are attained by breaking-in of an opposed shaft by the nodular Si and the like of this alloy.

(c) A small amount of Cr is added to an Al-Sn based alloy to prevent coarsening of the Sn phase, hence enhancing the fatigue resistance of Al alloy (U.S. Pat. No. 4,153,756 assigned to the present applicant)

(d) Powder-metallurgy alloy utilizing the melt-quenched powder (for example Japanese Patent Publication No. 2535789). In this publication, aluminum-alloy melt containing from 15 to 30 wt % of Si is quenched and solidified as powder. The resultant powder is hot-pressed and then hot-extruded. As a result, sliding material having improved properties, such as wear-resistance, mechanical strength, light-weight property, and low expansion-coefficient, is produced.

Since Pb, which is contained in many cases in the copper alloys, such as kelmet, i.e., a principal sliding material other than aluminum alloy, is an environment-pollution material, it is predicted in future situations that the use of copper alloys may be restricted.

A technique of flame-spraying the Cu-alloy sliding-material is known. It is shown in International Publication WO95/25224 filed by the present applicant. “Tribologist” Vol. 41, No.11 (1996), pages 19-24 (in Japanese) generally illustrates how to apply the flame-spraying technique to the production of sliding material. However, regarding the flame-spraying of aluminum-based alloy, only pure Al is mentioned.

The alloys of (a)-(c) mentioned above are difficult to cast and are more difficult to form, such as by forging, when the Si content exceeds 20%. The wear resistance of these alloys is, therefore, limited by the Si amount. A large amount of Si can be contained in the alloy (d). Such forming methods as hot-pressing and hot-extrusion are, however, necessarily employed. It is, therefore, practically impossible to use (d) for a hemi-spherical bearing which will be used for the main bearing (usually referred to as “metal”) of an internal combustion engine.

The present inventors therefore, conducted research with the aim that: the Al—Si based aluminum alloys in a eutectic region or a hyper-eutectic region would be formed into various shapes of the sliding parts by means of a simple method; and, considerably improved properties than those of the conventional melted material would be demonstrated.

### DISCLOSURE OF INVENTION

The present inventors energetically carried out experiments and discovered that: the flame-sprayed Al—Si based aluminum alloys in a eutectic region or a hyper-eutectic region exhibit improved adhesiveness with a substrate; and, the Si particles are refined. The present invention was thus completed.

The present first invention is a flame-sprayed aluminum-alloy, which contains from 20 to 60% by weight of Si, the balance being essentially Al, and further, the granular Si particles are dispersed in the matrix thereof. The present second invention is a flame-sprayed aluminum-alloy, which contains from 20 to 60% by weight of Si, from 0.1 to 30% by weight of Sn, the balance being essentially Al, and further the granular Si particles and Sn are dispersed in the matrix thereof.

The flame-spraying is based on the definition of Glossary

The flame-spraying is based on the definition of Glossary Dictionary of JIS Industrial Terms, 4 th edition, page 1946 (spraying) and indicates that “material is converted to molten or half-molten state by a heat source and is blown onto a substrate to form a film.” More specifically, the “material” is aluminum-alloy or its raw material, for example Al powder and Si powder. The half-molten state indicates that such a solid-liquid coexistent state as is realized in a high-Si Al alloy having a high melting-point. Alternatively, the half-molten state indicates that a portion of the powder does not melt, as is explained hereinbelow.

The present invention is explained in detail hereinafter. The percentage is weight % unless otherwise specified.

EP 0713972A1 filed by the present applicant along with the other applicant provides a detailed explanation of the flame-sprayed copper alloy by referring to an example of Cu-Pb alloy. The rapid cooling and solidification of molten particles is common in the Al-alloy example. One of the features of the flame-sprayed Al—Si alloy is that an additive element (Si) has a higher melting point than that of the matrix element (Al). As a result, Si in the granular form is finely dispersed in the aluminum matrix in a large amount. Thus, Si enhances the hardness and hence wear-resistance of the alloy. This is an effect obtained in the Al—Si based alloy according to the present first invention.

In the present invention, the granular Si particles do not have the same shape as seen in the primary Si of the conventional melted alloy or the Si particles of the rolled alloy. They have a one-directional, lengthwise property. Rather the granular Si particles of the present invention have spheroidal, nodular, polygonal or an irregular shapes, not classified as the former three shapes, and have almost the same dimension in any direction. Furthermore, a noticeable distinction between the primary Si and eutectic Si seen in the conventional melted alloys disappear in the case of the present invention. The granular Si particles may be the same as the nodular particles of the German patent referred to above, but are generally more rounded than the nodular particles. The rounded shape can be expressed quantitatively in terms of the short-diameter/long-diameter. The granular Si of the present invention has a ratio of generally 1/3 or more.

The large amount of finely dispersed granular Si particles suppresses seizure due to adhesion of the aluminum matrix with the opposite shaft.

The hardness of the flame-sprayed alloy is in a range of from Hv100 to 600. Since the hardness of the conventional 12% Si-containing alloy is Hv70 to 150, the flame-sprayed layer according to the present invention can be said to be very hard.

The composition of the aluminum-alloy according to the present invention is hereinafter explained.

When the Si content of the aluminum-alloy according to the present invention is less than 12%, the enhancement effects of wear resistance and seizure resistance are slight. On the other hand, when the Si content exceeds 60%, the strength so drastically lowers as to impair wear resistance. A preferable Si content is from 15 to 50%. When the size of Si particles exceeds 50 μm, the separation of Si particles is liable to occur. A preferable size is from 1 to 40 μm.

Next, the Al—Si-Sn based alloy of the present second invention exhibits improved seizure-resistance and wear-resistance as required in wear-resistant and seizure-resistant parts, such as the metal, bush, for which Al-Sn alloy has been heretofore used. The shape and content of Si as in the description of the first invention is common. Sn is a component for imparting the lubricating property and compatibility. Sn disperses uniformly in the aluminum matrix. In addition, Sn preferentially adheres to the opposed shaft. Sn therefore impedes the sliding of materials of the same kind, i.e., Al adhering to the opposed shaft and Al of the bearing, with the result that the seizure resistance is enhanced. When the Sn content is less than 0.1%, it is not effective in enhancing the lubricating property and the like. On the other hand, when the Sn content exceeds 30%, the strength of alloy is lowered. A preferable Sn content is from 5 to 25%. Ultra-fine particles of submicrons among the Si particles, present in the inventive alloy in a large amount, seem to be present in the extreme vicinity of Sn and to suppress its coarsening, thereby enhancing the fatigue resistance.

The aluminum alloy according to the present first and second invention can contain the following optional elements.

Cu: Cu is solid-dissolved in the aluminum matrix at super-saturation and thus enhances its strength. Cu thus suppresses adhesive wear of aluminum and wear due to separation of Si particles. In addition, a part of Cu forms with Sn, a Sn-Cu intermetallic compound and hence enhances the wear-resistance. However, when the Cu content exceeds 7.0%, the alloy is hardened too much to provide appropriate sliding material. A preferable Cu content is from 0.5 to 5%.

Mg: Mg is combined with a part of Si and forms a Mg-Si intermetallic compound. Mg, thus, enhances the wear resistance. However, when the Mg content exceeds 5.0%, coarse Mg phase formed impairs the sliding properties.

Mn: Mn is solid-dissolved in the aluminum matrix at super-saturation and thus enhances its strength. The effects attained by Mn are the same as those by Cu. However, when the Mn content exceeds 1.5%, the alloy is hardened too much to provide appropriate sliding material. A preferable Mn content is from 0.1 to 1%.

Fe: Fe is solid-dissolved in the aluminum matrix at super-saturation and thus enhances its strength. The effects attained by Fe are the same as those by Cu. However, when the Fe content exceeds 1.5%, the alloy is hardened too much to provide appropriate sliding material. A preferable Fe content is from 0.1 to 1%.

Ni: Ni is solid-dissolved in the aluminum matrix at super-saturation and thus enhances its strength. The effects attained by Ni are the same as those by Cu. However, when the Ni content exceeds 8%, the alloy is too hardened to provide appropriate sliding material. A preferable Ni content is from 0.1 to 5%.

Subsequently, the characteristics of the flame-sprayed alloy are described.

In the present invention, various flame-spraying methods listed in FIG. 2 of Tribologist, ibid. page 20, FIG. 2 can be employed. Among them, high-velocity oxyfuel flame-spraying method (HVOF, high velocity oxyfuel) can be preferably employed. It seems that the characterizing morphology of Si particles can be obtained by this method, since it has features described on page 20, right column, lines 4 through 13 of Tribologist, ibid. Flame-sprayed Al is so rapidly cooled and solidified that a large amount of Si is solid-dissolved to harden Al. It has, therefore, a feature of holding the Si particles at high strength. Separation of Si particles and the wear due to such separation can, therefore, be suppressed. Atomized powder of alloys such as Al—Si alloy, Al—Si-Sn alloy and the like can be used as the flame-spraying powder. These atomized powders may be completely melted on the substrate and then solidified. Alternatively, a partly unmelted atomized powder may be applied on the substrate, so that the unmelted structure of powder remains.

The flame-spraying conditions are preferably: from 0.45 to 0.76 MPa of the oxygen pressure; from 0.45 to 0.76 MPa of fuel pressure; and from 50 to 250 mm of flame-spraying distance. A preferable thickness for the flame-sprayed layer is from 10 to 500,μm, particularly from 10 to 300 μm.

Various metal substrates, such as iron, copper, aluminum and the like can be used as the substrate to form a flame-sprayed alloy thereon. A substrate may have any shape, such as sheet, round disc, tube and the like. When the surface of a substrate is roughened by means of shot-blasting and the like, to preferably Rz 10 to 60 μm of surface roughness, then the adhesive strength of a film can be increased. More specifically, the measurement of adhesive strength of a film by a shear-fracture testing method revealed that: adhesive strength of flame-sprayed Ni film on the shot-blasted steel substrate was 30 to 50 MPa; while the adhesive strength of the film according to the present invention was 40 to 60 MPa. This is higher than that of the flame-sprayed Ni film, which has been heretofore reputed to have good adhesiveness.

Heat treatment can be applied to the flame-sprayed alloy to adjust the hardness.

In the case of using the flame-sprayed alloy without application of an overlay, the flame-sprayed surface is preferably finished to Rz 3.2 μm or less. In the case of using the overlay, various soft coatings exhibit excellent compatibility, such as Sn, Pb-Sn, MoS₂, and MoS₂-graphite-based coating, so as to enhance the seizure-resistance.

The present invention is described by way of the examples.

### BRIEF EXPLANATION OF DRAWING

FIG. 1 is a photograph showing the microscope structure of the flame-sprayed aluminum-alloy according to Example 1.

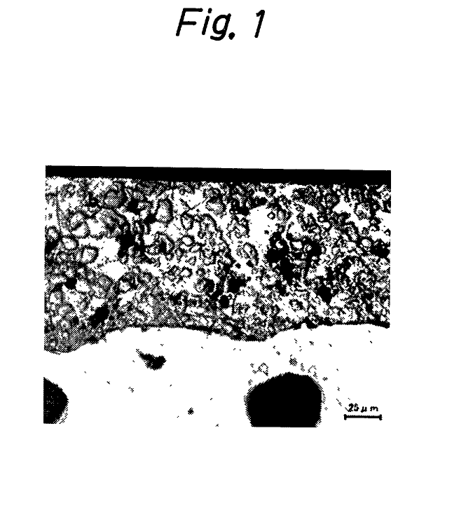

### BEST MODE FOR CARRYING OUT INVENTION

### EXAMPLE 1

Mixture of metal powder was prepared to provide the compositions shown in Table 1. Meanwhile commercially available pure-aluminum rolled sheets were subjected to the shot-blasting by steel grids (0.7 mm of size) to roughen the surface to Rz 45 μm.

Using a HVOF type flame-spraying machine (DJ, product of Sulzer Meteco Co., Ltd.) the flame spraying was carried out under the following conditions.

Oxygen pressure: 150 psi

Fuel pressure: 100 psi

Flame-spraying distance: 180 mm

Thickness of flame-sprayed layer: 200 μm

The resultant flame-sprayed layer had a hardness of Hv=180-250, and an average size of granular Si partilcles of 3 μm. The surface of the flame-sprayed layer was finished to Rz 1.2 μm. The wear test was then carried out under the following conditions, with a steel shaft (hardened SUJ2, 15 mm of diameter) being used as the opposed shaft. The wear test was carried out under the following conditions.

Testing machine: three-pin/disc friction wear testing machine

Load: 40 kg/cm

Number of revolution: 700 rpm

Lubrication: naphthene-based oil

Testing time: 120 minutes

The results are shown in following Table 1

TABLE 1
Composition of Flame-sprayed Aluminum-Alloys (wt %) and
Wear Amount (μm) of Examples

| Num- | | | | | | | | | Wear |
|---|---|---|---|---|---|---|---|---|---|
| ber | Al | Si | Sn | Cu | Mg | Mn | Fe | Ni | Amount |
| 1 | Bal | 40 | — | — | — | — | — | — | 3 |
| 2 | Bal | 35 | 10 | — | — | — | — | — | 2 |
| 3 | Bal | 49 | — | 2.8 | 0.7 | 0.5 | 0.7 | — | 1 |
| 4 | Bal | 21.7 | 30 | 4.3 | — | — | — | 2.2 | 2 |

### COMPARATIVE EXAMPLE 1

The flame-sprayed layer of pure aluminum was formed under the same conditions as in Example 1. The same wear test was carried out.

### COMPARATIVE EXAMPLE 2

Al—Si alloy containing 17% of Si, exhibits almost maximum wear resistance among the cast alloys. Such 17% Si-containing Al alloy was cast in a sand mold to prepare a test specimen. This was tested as in Example 1. The results are shown in Table 2.

TABLE 2
Composition of Flame-sprayed Aluminum-Alloys (wt %) and
Wear Amount (μm) of Comparative Examples

| Num- | | | | | | | | | Wear |
|---|---|---|---|---|---|---|---|---|---|
| ber | Al | Si | Sn | Cu | Mg | Mn | Fe | Ni | Amount |
| 1* | 100 | — | — | — | — | — | — | — | 50 |
| 2+ | Bal | 17 | — | — | — | — | — | — | 4 |

Remarks: 1*-flame-sprayed material, 2+-cast material

### EXAMPLE 2

The flame-sprayed alminum alloy number 1 in Example 1, as well as this alloy with a 10 to 20 μm thick coating of MoS₂+polyamide-imide resin and a Sn-plating coating, were subjected to a test for seizure resistance. The method for testing seizure resistance was as follows.

Testing machine: three-pin/disc friction wear testing machine

Load: successive increasing of load

Number of revolution: 700 rpm

Lubrication: naphthene-based oil

The following seizure load was obtained as a result of the test.

No soft coating: seizure at 80kg/cm²

Coating of MoS₂+ polyamide-imide resin: more than 150 kg/cm²

Sn-plating coating: more than 150 kg/cm²

### INDUSTRIAL APPLICABILITY

As is described hereinabove, the hyper-eutectic Al—Si alloy can be shaped into various sliding parts, such as a shoe and a metal. In addition, the performances of the inventive alloy is superior to that of the conventional melted Al—Si alloy. The present invention therefore greatly contributes to the development of sliding parts.

1. A flame-sprayed aluminum-alloy particularly suited as sliding material, wherein the aluminum alloy contains from 12 to 60% by weight of Si, the balance being essentially Al, and further the granular Si particles are dispersed in the matrix thereof.

2. A flame-sprayed aluminum-alloy, which contains from 12 to 60% by weight of Si, from 0.1 to 30% by weight of Sn, the balance being essentially Al, and further the granular Si particles and Sn being dispersed in the matrix thereof.

3. A flame-sprayed aluminum alloy according to claim 1 or 2, wherein said alloy contains at least one element of the group consisting of: 7.0% by weight or less of Cu; 5.0% by weight or less of Mg; 1.5% by weight or less of Mn; 1.5% by weight or less of Fe; and 8.0% by weight or less of Ni.

4. A flame-sprayed aluminum alloy according to any one of claims 1 through 3, wherein the average particle diameter of said granular Si is 50 μm or less.

5. A flame-sprayed aluminum alloy according to any one of claims 1 through 4, wherein said alloy is applied on a metallic substrate having roughened surface.

6. A flame-sprayed aluminum alloy according to claim 5, wherein a soft film is applied on said flame-sprayed aluminum alloy.
